(19) United States
(12) Patent Application Publication
(10) Pub. No.: US 2024/0112211 A1
(43) Pub. Date: Apr. 4, 2024

(54) DATA PRICE DETERMINATION APPARATUS AND METHOD, AND STORAGE MEDIUM

(71) Applicant: CANON KABUSHIKI KAISHA, Tokyo (JP)

(72) Inventors: RYUYA OKA, Kanagawa (JP); SATOSHI IGETA, Kanagawa (JP)

(21) Appl. No.: 18/478,886

(22) Filed: Sep. 29, 2023

(30) Foreign Application Priority Data
Oct. 3, 2022 (JP) 2022-159715

(51) Int. Cl. G06Q 30/0201; G06Q 50/02

(52) U.S. Cl. CPC G06Q 30/0206; G06Q 50/02

(57) ABSTRACT

A data price determination apparatus includes acquires yield prediction data of a production target in agriculture, acquires a reference price, which is a reference sales price of the yield prediction data, acquires a sales price coefficient based on temporal variation of the yield prediction data, and corrects the reference price using the sales price coefficient and calculates a sales price of the yield prediction data.

### BACKGROUND

### Field

The present disclosure relates to a technique for determining a sales price of data.

### Description of the Related Art

A system that sells data has been known as an information providing service on the Internet.

For example, Japanese Patent Laid-Open No. 2005-100130 discloses a system for providing weather forecast information, crop growth/yield prediction information, and pest prediction information.

A system for fluctuating the price of a product based on the value of the product is known. Japanese Patent No. 5499523 discloses a technique of determining a quality rank of a crop based on a determination item and enabling a purchase price to be changed.

Growth data and yield prediction data of crops such as rice, vegetables, fruits, and flowers are important information. However, in the known technique disclosed in the above-described reference, even when there occurs an area where the growth of rice and vegetables is bad and the yield amount cannot be expected due to weather, pests and the like, the sales price of data by the information providing system is constant.

In a system where a sales price of data is changed after an area where a yield amount cannot be expected is found from external information, the value for the data is not high. If the sales price of data is changed in units of regions, yielding in the region is presumed to have a problem.

### SUMMARY

The present disclosure has been made in view of the problems described above, and provides a data price determination apparatus capable of appropriately determining a sales price of data such as crop growth data and yield prediction data.

According to a first aspect of the present disclosure, a data price determination apparatus comprises at least one memory storing a program and at least one processor, that when executing the program, is configured to cause the data price determination apparatus to acquire yield prediction data of a production target in agriculture, acquire a reference price, which is a reference sales price of the yield prediction data, acquire a sales price coefficient based on temporal variation of the yield prediction data, and correct the reference price using the sales price coefficient and calculate a sales price of the yield prediction data.

According to a second aspect of the present disclosure, a data selling system comprises a price determination device and a client device, wherein the price determination device and the client device are in communication with each other, and wherein the price determination device is configured to acquire yield prediction data of a production target in agriculture, acquire a reference price, which is a reference sales price of the yield prediction data, acquire a sales price coefficient based on temporal variation of the yield prediction data, and correct the reference price using the sales price coefficient and calculate a sales price of the yield prediction data, and wherein the client device is configured to request the data price determination apparatus to present a sales price of the yield prediction data a price determination device in communication with a client device.

According to a third aspect of the present disclosure, method for determining data price comprises acquiring yield prediction data of a production target in agriculture, acquiring a reference price, which is a reference sales price of the yield prediction data, acquiring a sales price coefficient based on a temporal variation of the yield prediction data, and correcting the reference price using the sales price coefficient to calculate the sales price of the yield prediction data.

Further features of the present disclosure will become apparent from the following description of exemplary embodiments with reference to the attached drawings.

### BRIEF DESCRIPTION OF THE DRAWINGS

FIG. 1 is a diagram illustrating a configuration of a data selling system according to an embodiment of the present disclosure.

FIG. 2 is a hardware configuration diagram of the data selling system.

FIG. 3 is a software configuration diagram of the data selling system.

FIG. 4 is a system configuration diagram of the data selling system.

FIG. 5A is a data configuration diagram.

FIG. 5B is a data configuration diagram.

FIG. 5C is a data configuration diagram.

FIG. 5D is a data configuration diagram.

FIG. 5E is a data configuration diagram.

FIG. 6 is a flowchart illustrating a calculation process of a sales price coefficient.

FIG. 7 is a flowchart illustrating a return process of a sales screen.

FIG. 8 is a diagram illustrating a user interface.

### DESCRIPTION OF THE EMBODIMENTS

Hereinafter, embodiments will be described in detail with reference to the attached drawings. The following embodiments are not intended to be limiting. Multiple features are described in the embodiments, but all such features are not necessarily required, and multiple features can be combined as appropriate. In the attached drawings, the same reference numerals are provided to the same or similar configurations, and redundant description thereof is omitted.

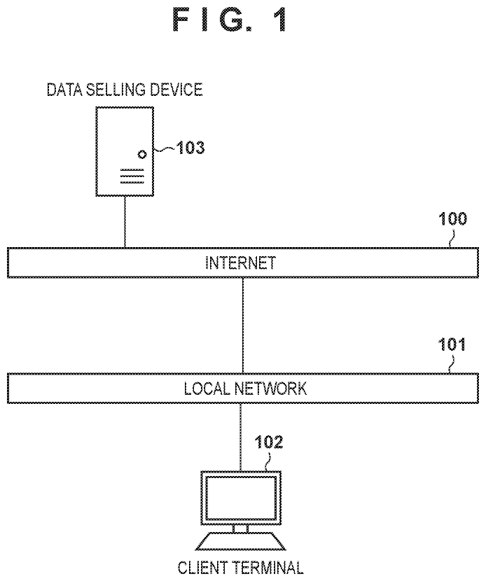

FIG. 1 is a diagram illustrating a configuration of a data selling system incorporating a data price determination apparatus according to an embodiment of the present disclosure. The present embodiment is a system that enables an information processing apparatus connected via the Internet 100 and Local Network 101 to appropriately determine a sales price of data and sales the data.

When a user requests for a sales screen of the data selling system, a client terminal 102 can acquire and display the sales screen with the price appropriately determined from a data selling device 103 via the Internet 100.

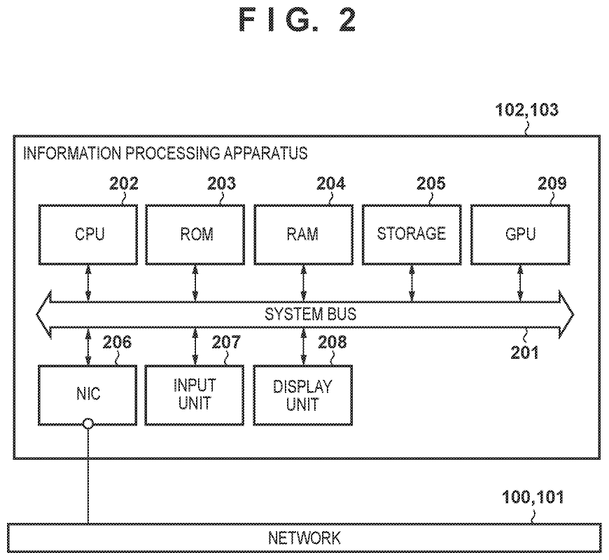

As illustrated in FIG. 2, both the client terminal 102 and the data selling device 103 are information processing apparatuses. Each information processing apparatus includes a system bus 201, a central processing unit (CPU) 202, a read only memory (ROM) 203, a random access memory (RAM) 204, a storage 205, a network interface card (NIC) 206, an input unit 207, a display unit 208, and a graphics processing unit (GPU) 209.

The system bus 201 includes an address bus, a data bus, and a control bus (not illustrated). The CPU 202 controls each component based on a control program, such as an operating system (OS), stored in the ROM 203 or the storage 205 or a program for performing control described below.

The ROM 203 stores various control programs and data. The RAM 204 has a work area of the CPU 202, a saving area for data at the time of error processing, a load area of a control program, and the like. The storage 205 stores each control program executed in the information processing apparatus 102, 103, data to be temporarily stored, and the like.

The NIC 206 communicates with other information processing apparatuses and the like via a network. The input unit 207 inputs operations and data to the information processing apparatus 102, 103 from a mouse, a keyboard, a sensor, or the like. The display unit 208 displays, for example, an icon, a message, a menu, and other user interfaces for managing the information processing apparatus 102, 103.

The GPU 209 processes drawing process of data to be displayed on the display unit 208 and a large amount of parallel processing. The GPU 209 can be incorporated in the CPU 202.

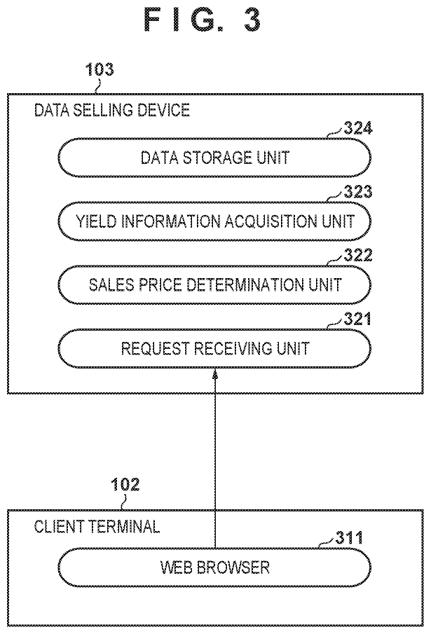

FIG. 3 is a diagram illustrating the respective software configuration of the data selling device 103 and the client terminal 102.

The web browser 311 included in the client terminal 102 acquires and displays information from the Internet 100 based on an instruction from a user. In another embodiment, a dedicated client application can be used instead of a web browser.

A request receiving unit 321 included in the data selling device 103 accepts a request such as login or logout from the web browser 311 based on a user's instruction, information and selling of sales data, and responds to a result.

A sales price determination unit 322 included in the data selling device 103 determines the sales price of data based on data stored in a data storage unit 324 and stores the determined sales price in the data storage unit 324.

A yield information acquisition unit 323 included in the data selling device 103 acquires growth data from a sensor or an affiliated system set in a field of a crop, which is the production target, in agriculture at a predetermined timing, generates yield prediction data from the acquired data, and stores the yield prediction data in the data storage unit 324. It is desirable to determine the timing of acquisition by matching the update of data of the acquisition destination or by calculating an optimal interval from the temporal variation of the crop growth data. In addition, data can be acquired at an arbitrary timing by an administrator.

The data storage unit 324 included in the data selling device 103 stores growth information and yield prediction data to be sold, the sales price determined by the sales price determination unit 322, the area information, and the user information. Data is read and stored when a request from a user is received or when a sales price is determined.

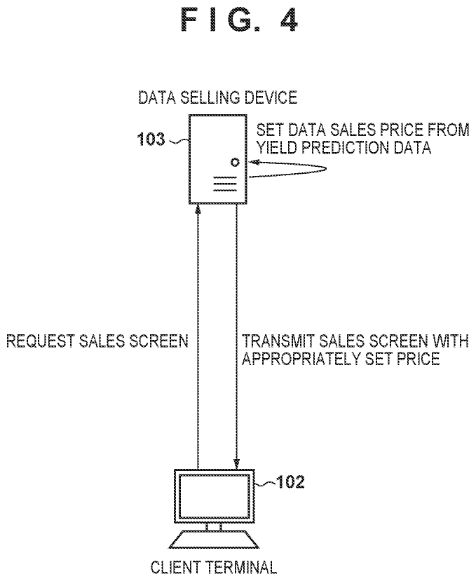

FIG. 4 is a diagram illustrating an example of a system configuration according to the present embodiment. When the user operates the client terminal 102 to request the data selling device 103 for a sales screen, the data selling device 103 returns the sales screen that can be displayed by the web browser 311 and where the yield prediction data being sold is set to an appropriate price.

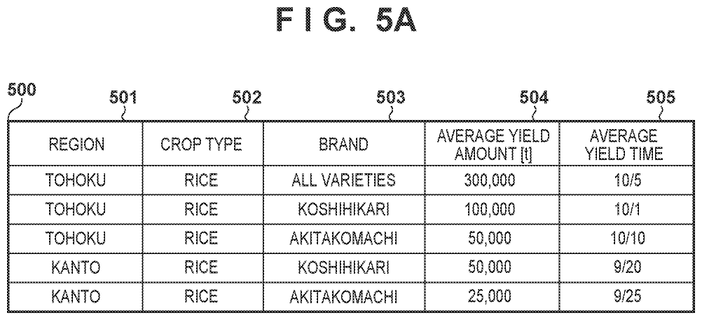

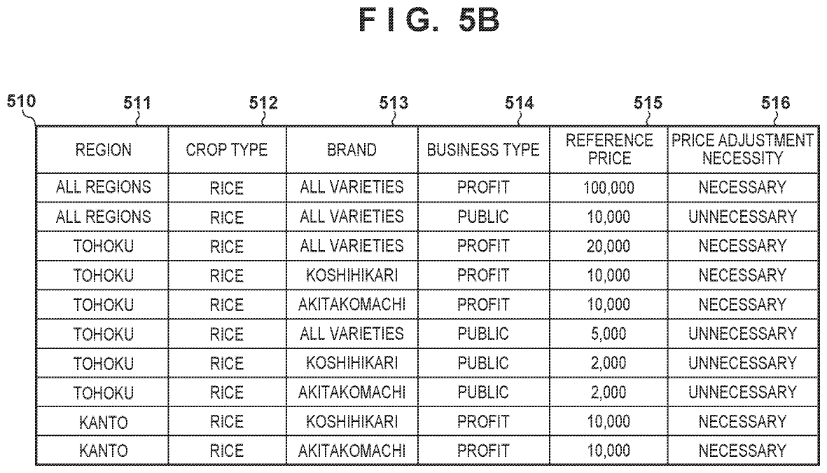

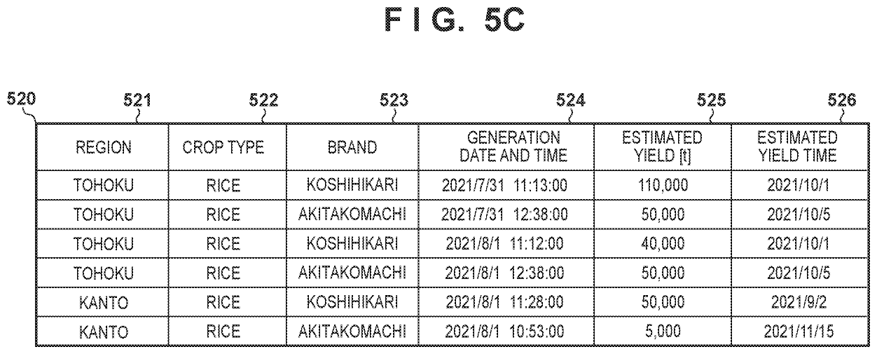

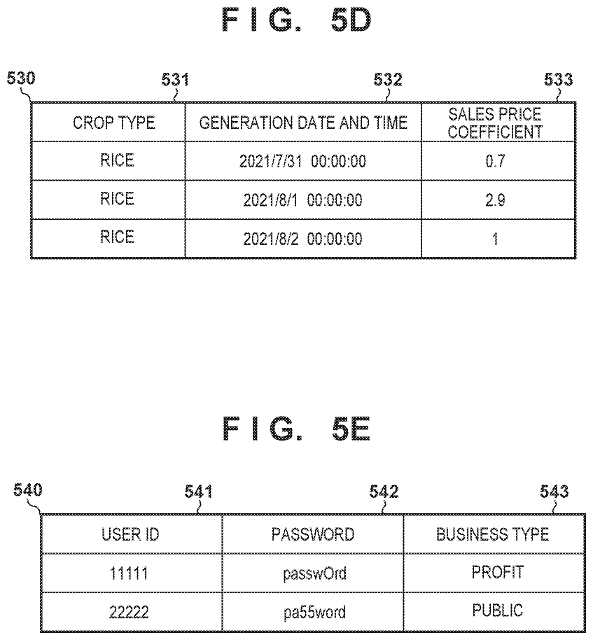

FIGS. 5A to 5E are diagrams illustrating examples of a data configuration stored in the data storage unit 324 according to the present embodiment. Data related to the sales price and data for calculating the sales price when the data selling device 103 returns the data sales screen to the client terminal 102 are stored. For description purposes, the data is described to be stored in the data storage unit 324 of the data selling device 103. However, this is not limiting, and the data can be stored or processed by another system and acquired via the Internet 100. The data structure described in FIGS. 5A to 5E are examples, and the data structure is not limited to thereto as long as it is a structure can calculate the sales price and present it to the user.

FIG. 5A illustrates an example of average yield data 500 indicating the past yield amount and yield time used when the data selling device 103 calculates the sales price coefficient data. A Region 501, a crop type 502, a brand 503, an average yield amount 504 and an average yield time 505 corresponding thereto are stored. The data registration is performed when yield performance data is input, but a calculation method and an acquisition method thereof are not seen to limited in the present embodiment.

FIG. 5B is an example of reference price data 510 indicating a region 511, a crop type 512, a brand 513, a business type 514, a reference price (reference sales price) 515 corresponding thereto, and a price adjustment necessity 516. The reference price 515 is a data price serving as a reference before controlling the sales price of the data. The sales price of the data is determined by adding a sales price coefficient determined based on the variation in the yield prediction data to the price (correcting with the sales price coefficient). A reference price 515 can be set for each user.

The price adjustment necessity 516 is assumed to prioritize the public interest by setting a flag that it is unnecessary for a group or a user having high public interest. For example, in the case of a user to which the price adjustment necessity 516 is set to be unnecessary, control is performed such that the sales price of data is changed to be low, the sales price of data due to variation in the yield prediction is unchanged, or the sales price is changed to be low when the yield prediction deteriorates and a sales price coefficient, described below, is high. In the present embodiment, only two types, profit and public, are illustrated as the business types 514. However, the business types can be classified into Non-Profit Organization (NPO), Non-Governmental Organization (NGO), administrative agency, and the like, or can be divided for each company or business organization. In addition to the two types of price adjustment necessity 516, “necessary” and “unnecessary”, a discount rate or the like when the sales price coefficient is high can be set.

FIG. 5C is an example of the yield prediction data 520 indicating a region 521, a crop type 522, a brand 523, a generation date and time 524 of the data, an estimated yield amount 525, and an estimated yield time 526. In the present embodiment, the data selling device 103 acquires, on a daily basis, the growth data including the position information of the sensor, the crop type, the brand, and the area from the field. Then, information on the estimated yield amount and the estimated yield time, which are the yield prediction data, is generated from the growth data using statistical information, AI, deep learning technology, and the like.

The data selling device 103 aggregates and registers data in units of the region 521, the crop type 522, and the brand 523 from the yield prediction generated in units of fields. The estimated yield amount is obtained by calculating a field of a region, a crop type, and a brand as a unit to be aggregated based on the acquired growth data and adding up all estimated yield amounts of the field. As the estimated yield time, the region, the crop type, and the brand of the unit to be aggregated are obtained based on data acquired from the field, and a weighted average obtained by weighting the area of the field is set as the estimated yield time.

These aggregations are performed for each unit of data to be sold, such as a national unit, a local unit, a prefectural unit, and a municipal unit. The above description on aggregation is based on the assumption that growth data of all fields can be acquired. However, regarding a field where data cannot be acquired, the yield prediction per unit of the closest farm field, the nearby weather or soil, and the farm field with close geographical conditions can be used as the data of the field where data cannot be acquired.

The method of aggregating the sum for the estimated yield amount and the weighted average for the estimated yield time has been provided as an example. This is not seen to be limiting, and the estimated yield amount per unit area can be used or another method can be used.

The regions where the cultivation season is determined in consideration of the yield prediction where the combination of the production region and the shipping destination region is close or the shipment time of the neighboring region can be grouped. When such grouping is performed, in a case where it is determined that there is a crop failure or a growth delay in any yield prediction in the group, it is possible to predict a possibility that there is a correlation with respect to other regions in the same group and a possibility that a supply shortage occurs in the region of same shipment destination. Therefore, it can be used at the time of calculating a sales price coefficient described below. It is desirable that the registration process of the yield prediction data is performed at a frequency corresponding to the update frequency of the growth data. For description purposes, generation date and time 524 is indicated by year, month, day, and time, but is desirably treated as UNIX® time for calculation and management.

FIG. 5D is an example of the sales price coefficient data 530 indicating the crop type 531, the generation date and time 532, and the sales price coefficient 533. In the present embodiment, the yield prediction data is registered daily based on the update frequency. The sales price coefficient determined by the data selling device 103 based on the yield prediction up to the previous day and the variation from the average yield data is registered.

FIG. 5E illustrates user data 540 in which a user ID 541, a password 542, and a business type 543 are registered. A user ID, a password, and a business type for determining a sales price for displaying a sales screen for each user are registered.

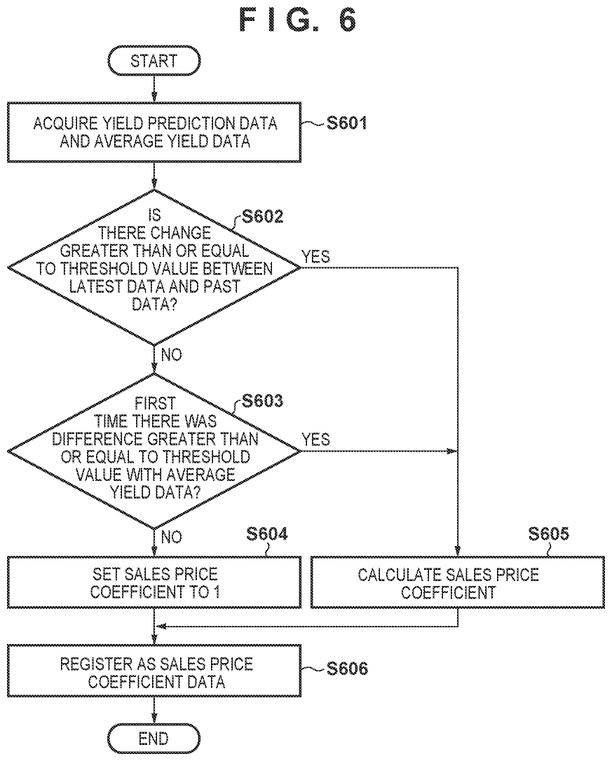

FIG. 6 is a flowchart for determining a daily sales price coefficient in the present embodiment. The data selling device 103 determines the daily sales price coefficient for the crop type 531 based on the yield prediction data 520 at the set timing. The determined sales price coefficient is registered in the sales price coefficient data 530. The set timing referred to here is assumed to be a timing based on a periodic schedule set by the system administrator or update of the growth data and the yield prediction data to be collected.

In step S601, the CPU 202 of the data selling device 103 acquires the average yield data 500 and the yield prediction data 520 illustrated in FIGS. 5A and 5C from the data storage unit 324.

In step S602, the CPU 202 of the data selling device 103 compares the latest estimated yield amount and estimated yield time, and the values before the previous day for each region, crop type, and brand based on the yield prediction data acquired in step S601, and determines whether there is a change greater than or equal to a threshold value. The CPU 202 of the data selling device 103 proceeds the process to step S605 in a case where there is a change of greater than or equal to the threshold value, and proceeds the process to step S603 in a case where there is no change.

The threshold value in this case can be any programmable threshold value such as a determined fixed value, a divergence rate from the average of the differences so far, and a standard deviation from the average value. Specifically, the average value and the standard deviation of the estimated yield amount and the estimated yield time are calculated from the values of all the dates of the year corresponding to the same region, crop type, and brand. This standard deviation is used as a threshold value with respect to an absolute value of the difference of the estimated yield amount or the estimated yield time of the latest date and the average value. When the difference is greater than or equal to the threshold value, it is determined that there is a large variation in the yield prediction.

In step S603, the CPU 202 of the data selling device 103 determines whether the difference of greater than or equal to the threshold value occurs for the first time with the average yield data in the latest value of the yield prediction data acquired in step S601. Similarly to step S602, the threshold value in this case can be any threshold value as long as it is a programmable threshold value. The CPU 202 of the data selling device 103 proceeds the process to step S605 in a case where there is a difference of greater than or equal to the threshold value, and proceeds the process to step S604 in a case where there is no difference.

In step S604, the CPU 202 of the data selling device 103 determines that there is no change in the yield prediction for adjusting the price, and sets “1” as the calculated sales price coefficient. The fact that there is no variation can be regarded as a decrease in the value of the data to be sold, and can be gradually reduced based on the sales price coefficient immediately before. It is assumed that a minimum sales price coefficient is determined and reduction by one percent is made until the sales price coefficient reaches such a value. The reduction rate and the reducing method are not particularly limited.

In step S605, the CPU 202 of the data selling device 103 calculates a sales price coefficient. A method of setting a simple difference between the latest yield prediction and the previous data or a ratio with the previous day as the sales price, a method of setting a ratio of a difference between the latest yield prediction and the average value with respect to a standard deviation as the sales price coefficient, or the like are examples of methods of calculating the sales price coefficient. A method of determining using a table where the sales price coefficient is defined for each difference is also applicable. Any method can be used as long as it is a programmable method.

In the sales price coefficient data 530 of FIG. 5D, it is illustrated that the sales price coefficient data is aggregated and stored only for the crop type. However, this is not seen to be limiting, and the sales price coefficient data can be stored for the crop type, region, or brand. When the sales price coefficient of the calculated crop type, region, and brand is registered as the sales price coefficient data 530, only the one having the maximum sales price coefficient can be registered. A numerical value calculated in consideration of the influence on the market can be registered as the sales price coefficient of the crop type.

Specifically, in the case of the sales price coefficient of the crop type corresponding to the production amount of the region, a weighted average obtained by weighting each value with the total production amount of the region after calculating the sales price coefficient for each of the region, the crop type, and the brand is set as the final sales price coefficient. The total production amount of the region calculates the sum of the production amount for each region based on the data of the average yield data 500 of FIG. 5A. Similarly, a weighted average obtained by weighting the ratio of the production amount in the brand or the producing region and the ratio of the sales amount in the region of the shipment destination can be used as the sales price coefficient of the crop type. With such a sales price coefficient, a data price according to more actual demand can be determined.

The sales price coefficient can be determined in consideration of the grouping described in the description of the yield prediction data 520 of FIG. 5C. Specifically, the largest sales price coefficient in the same group is treated as another sales price coefficient in the same group. In this way, since the correlation of the yield prediction is high and the sales price coefficient is large, price setting with a high profitability becomes possible. Other methods can be adopted, such as setting, instead of the same value, an average value with the largest sales price coefficient in the same group as the sales price coefficient of the region.

Returning to FIG. 6, in step S606, the CPU 202 of the data selling device 103 collectively stores the sales price coefficients calculated in step S604 or S605 in the data storage unit 324 in the sales price coefficient data 530 illustrated in FIG. 5D.

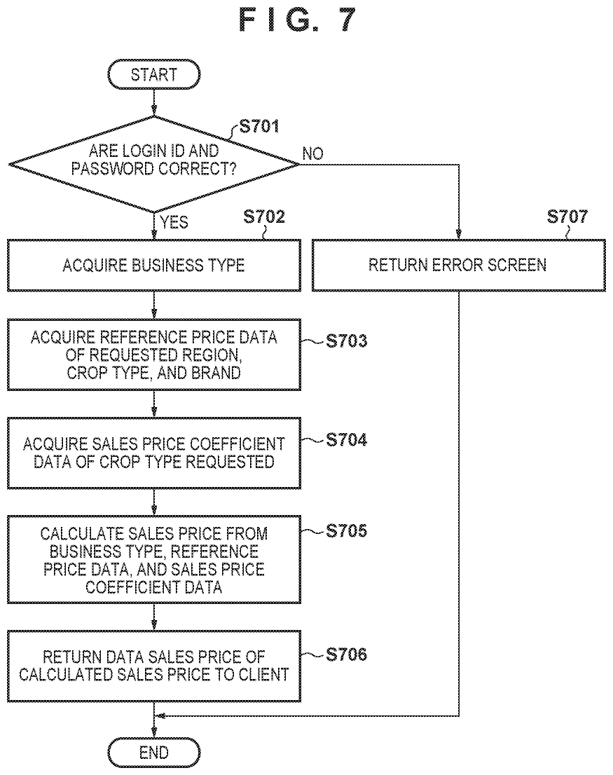

FIG. 7 is a flowchart executed when the user operates the client terminal 102 to request the sales screen to the data selling device 103. When requesting the sales screen, the client terminal 102 receives the user ID and the password or the business type, and information on the region, the crop type, and the brand to be displayed on the sales screen. In a case where these pieces of information are not included in the request, the data selling device 103 can operate assuming that all the pieces of information are designated.

In step S701, the CPU 202 of the data selling device 103 determines whether the user ID and the password accepted together with the display request of the sales screen from the client terminal 102 are correct. Specifically, the user data is checked by comparing with the user data 540 in the data storage unit 324 illustrated in FIG. 5E. The CPU 202 of the data selling device 103 proceeds the process to step S702 when the user ID and password are correct, and proceeds the process to step S707 when the user ID and password are not correct. The flow of enabling the user to log-in is described, but since it is sufficient to identify the business type of the user, the sales screen can be requested by designating the business type.

In step S702, the CPU 202 of the data selling device 103 acquires the business type 543 associated with the user ID 541 checked in step S701 from the data storage unit 324.

In step S703, the CPU 202 of the data selling device 103 acquires the reference price data 510 of the requested region, crop type, and brand from the data storage unit 324.

In step S704, the CPU 202 of the data selling device 103 acquires the latest sales price coefficient data 530 of the requested crop type from the data storage unit 324.

In step S705, the CPU 202 of the data selling device 103 multiplies the sales price coefficient acquired in step S704 with respect to the reference price associated with the business type, all the requested crop types and the brand acquired in step S703. Then, a sales price for the user is calculated.

In a case where the price of only a specific region or brand is changed, it is possible to distinguish that there is a problem in the region or brand from the price, and thus the value of the data lowers. By multiplying the coefficient for each crop type, there is an effect of making it difficult to presume that there is a problem in a specific region or brand. At this time, in a case where the price adjustment necessity 516 is unnecessary, this calculation is not performed, so that data can be provided at a low price with respect to a selling destination with high public interest. When a discount rate is set for the price adjustment necessity, a price to which the discount is applied is calculated. In addition, when set to be calculated as the reciprocal, the sales price can be calculated from the reciprocal of the sales price coefficient with one as the upper limit.

In step S706, the CPU 202 of the data selling device 103 returns, to the client terminal 102, the data sales screen to which the sales price calculated in step S705 is set.

In step S707, when the user ID and password are not correct, the CPU202 of the data selling device 103 returns an error screen to the client terminal 102.

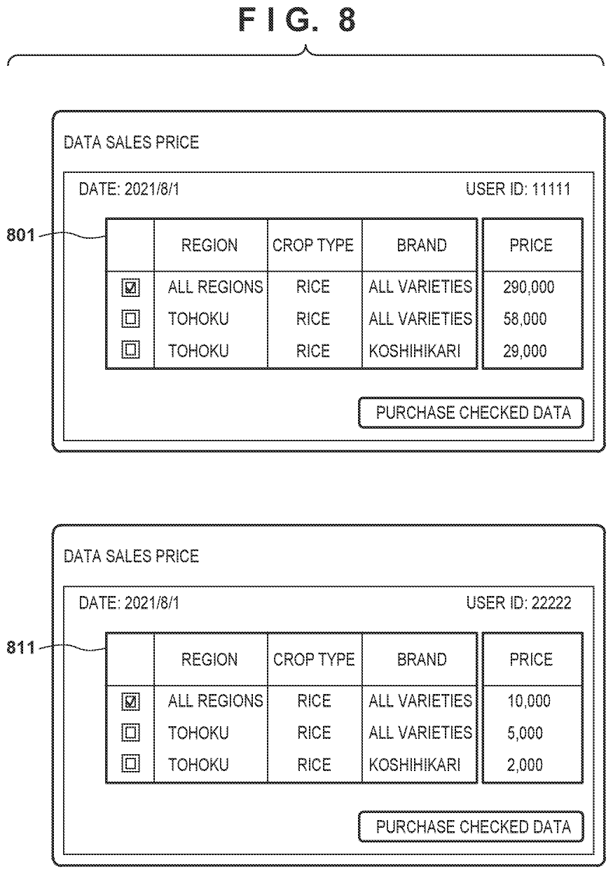

FIG. 8 is a diagram illustrating an example of a sales screen returned from the data selling device 103 to the client terminal 102.

The user ID 11111 and the user ID 22222 have business types of commercial and public, respectively. As illustrated in FIGS. 5A to 5E, different prices processed according to the above-described processing example are displayed in the sales price list 801 and the sales price list 811 as the sales price of the data.

### Other Embodiments

Embodiment(s) of the present disclosure can also be realized by a computer of a system or apparatus that reads out and executes computer executable instructions (e.g., one or more programs) recorded on a storage medium (which may also be referred to more fully as ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-159715, filed Oct. 3, 2022, which is hereby incorporated by reference herein in its entirety.

What is claimed is:

1. A data price determination apparatus comprising:
at least one memory storing a program; and
at least one processor, that when executing the program, is configured to cause the data price determination apparatus to:
acquire yield prediction data of a production target in agriculture;
acquire a reference price, which is a reference sales price of the yield prediction data;
acquire a sales price coefficient based on temporal variation of the yield prediction data; and
correct the reference price using the sales price coefficient and calculate a sales price of the yield prediction data.

2. The data price determination apparatus according to claim 1, wherein the sales price coefficient is calculated and acquired based on a temporal variation of the yield prediction data.

3. The data price determination apparatus according to claim 2, wherein the sales price coefficient is calculated when a difference of greater than or equal to a threshold value exists between a latest yield prediction data and a past yield prediction data.

4. The data price determination apparatus according to claim 2, wherein the sales price coefficient is set to one when no difference of greater than or equal to a threshold value exists between a latest yield prediction data and a past yield prediction data.

5. The data price determination apparatus according to claim 2, wherein the sales price coefficient is calculated when a difference of greater than or equal to a threshold value occurs for a first time between a latest yield prediction data and an average yield data.

6. The data price determination apparatus according to claim 2, wherein a method of calculating the sales price coefficient is changed based on a selling destination of the yield prediction data.

7. The data price determination apparatus according to claim 2, wherein the sales price coefficient is calculated based on an influence of a brand of the production target on a market.

8. The data price determination apparatus according to claim 2, wherein the sales price coefficient is calculated based on grouping of the yield prediction data.

9. The data price determination apparatus according to claim 2, wherein a final sales price coefficient is calculated by weighting the sales price coefficient for each region based on a production amount for each region where the production target is produced.

10. The data price determination apparatus according to claim 1, wherein a sales price of the yield prediction data is calculated by multiplying the reference price by the sales price coefficient.

11. A data selling system comprising:
a price determination device; and
a client device,
wherein the price determination device and the client device are in communication with each other, and
wherein the price determination device is configured to:
acquire yield prediction data of a production target in agriculture,
acquire a reference price, which is a reference sales price of the yield prediction data,
acquire a sales price coefficient based on temporal variation of the yield prediction data, and
correct the reference price using the sales price coefficient and calculate a sales price of the yield prediction data, and
wherein the client device is configured to request the data price determination apparatus to present a sales price of the yield prediction data.

12. A method for determining data price, the method comprising:
acquiring yield prediction data of a production target in agriculture;
acquiring a reference price, which is a reference sales price of the yield prediction data;
acquiring a sales price coefficient based on a temporal variation of the yield prediction data; and
correcting the reference price using the sales price coefficient to calculate the sales price of the yield prediction data.

13. A non-transitory computer-readable storage medium storing a program for causing a computer to execute a method for determining data price, the method comprising:
acquiring yield prediction data of a production target in agriculture;
acquiring a reference price, which is a reference sales price of the yield prediction data;
acquiring a sales price coefficient based on a temporal variation of the yield prediction data; and
correcting the reference price using the sales price coefficient and calculate a sales price of the yield prediction data.
